(19) United States
(12) Patent Application Publication
(10) Pub. No.: US 2007/0152490 A1
(43) Pub. Date: Jul. 5, 2007

(54) SEAT ASSEMBLY FOR AUTOMOBILE

(75) Inventor: Seung Kyu Oh, Seoul (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 11/419,141

(22) Filed: May 18, 2006

(30) Foreign Application Priority Data
Dec. 20, 2005 (KR) 10-2005-0126181

(51) Int. Cl. A47C 7/02; G01G 19/52; B60K 28/00

(52) U.S. Cl. 297/452.1; 180/273; 177/144

(57) ABSTRACT

A seat assembly for an automobile includes a support unit for supporting an overloaded seat cushion frame to prevent an overload applied to the seat cushion frame from being entirely applied to a passenger sensor to thereby prevent the passenger sensor from being damaged or deformed. The support unit comprises a stopper for limiting a downward movement of the seat cushion frame by longer than a certain distance and a stopper hooking part integrally formed at the seat cushion frame and caught by the stopper when the seat cushion frame is downwardly moved by longer than the certain distance. Thus, the structure is simple and the cost can be reduced.

This Nonprovisional application claims priority under 35 U.S.C. §119(a) on Patent Application No. 10-2005-0126181 filed in Korea on Dec. 20, 2005, the entire contents of which are hereby incorporated by reference.

### BACKGROUND OF THE INVENTION

1. Field of the Invention

The present invention relates to a seat assembly for an automobile and, more particularly, to a seat assembly for an automobile capable of enhancing durability and reliability of a passenger sensor by preventing the passenger sensor from being overloaded.

2. Description of the Related Art

FIG. 1 is a perspective view showing a cushion frame of a vehicle seat in accordance with a related art and FIG. 2 is a perspective view showing a portion of a set bracket and a rail in accordance with the related art.

The vehicle seat in accordance with the related art includes a seat cushion part allowing a passenger to sit thereon and supporting a load of the passenger and a seat back part coupled with an upper portion of the seat cushion part to support the back of the passenger.

The seat cushion part includes a seat cushion frame 2 forming a frame and a seat cushion (not shown) coupled with the seat cushion frame 2 and made of a foam or fabric material.

The seat cushion frame 2 is installed to be slidable in a forward/backward direction by means of a rail 4 provided on a floor panel (not shown) of an automobile.

A set bracket 6 is mounted at an upper side of the rail 4 and includes a buckle mounting hole 6a for allowing a buckle (not shown) for protecting the passenger to be mounted therein

A passenger sensor 10 for sensing a load of the passenger is installed at the vehicle seat, specifically, between the set bracket 6 and the seat cushion frame 2.

Herein, the passenger sensor 10 is fixed at the seat cushion frame 2 by a coupling bracket 12 formed in a bent shape.

The passenger sensor 10 is a pressure sensor for sensing a load of the passenger and electrically connected with an airbag control unit (not shown) of an airbag system for protecting the passenger in case of a vehicle accident.

The passenger sensor 10 senses the load, a physical figure and a position of the passenger according to a pressure applied from the seat cushion frame 2, and when a vehicle accident occurs, the airbag control unit (not shown) controls deployment of an airbag according to a signal from the passenger sensor 10.

However, the related art vehicle seat has a problem that when the seat cushion frame 2 is overloaded, the passenger sensor 10 is also overloaded and thus can be damaged.

### SUMMARY OF THE INVENTION

The present invention is designed to solve such problem of the related art, and therefore, an object of the present invention is to provide a seat assembly for automobile capable of enhancing durability and reliability of a passenger sensor by preventing the passenger sensor from being overloaded.

To achieve the above object, there is provided a seat assembly for an automobile including: a seat cushion frame for forming a portion on which a passenger is to be seated; a rail for slidably guiding the seat cushion frame in forward and backward directions; a passenger sensor provided at a lower side of the seat cushion frame and sensing a load of the passenger; and a support unit provided between the seat cushion frame and the rail and supporting an overload of the seat cushion frame when the seat cushion frame is overloaded.

The support unit is a stopper which is mounted at the rail and limits a downward movement of the seat cushion frame when the seat cushion frame is downwardly moved by longer than a certain distance.

The support unit includes a stopper hooking part protrusively formed at the side of the seat cushion frame to allow the seat cushion frame to be caught by the stopper when the seat cushion frame is downwardly moved by longer than the certain distance.

The stopper is mounted at a set bracket installed at an upper side of the rail.

The set bracket includes a stopper mounting hole for mounting the stopper therein.

The stopper is bolt-engaged in the stopper mounting hole.

The stopper hooking part includes a stopper through hole allowing the stopper to penetrate therethrough.

An inner circumferential surface of the stopper through hole is separated by a certain interval from an outer circumferential surface of the stopper.

The stopper hooking part includes a buckle mounting hole to allow a buckle of a seat belt for protecting a passenger to be mounted therein.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a seat cushion frame of a vehicle seat in accordance with a related art.

FIG. 2 is a perspective view showing a state that a set bracket and a rail are assembled in accordance with the related art.

FIG. 3 is a perspective view showing a seat assembly for automobile in accordance with the present invention.

FIG. 4 is a perspective view showing a seat cushion frame in accordance with the present invention.

FIG. 5 is a perspective view showing a set bracket in accordance with the present invention.

FIG. 6 is a perspective view showing a coupled state of a stopper in accordance with the present invention.

FIG. 7 is a side view showing the coupled state of the stopper in accordance with the present invention.

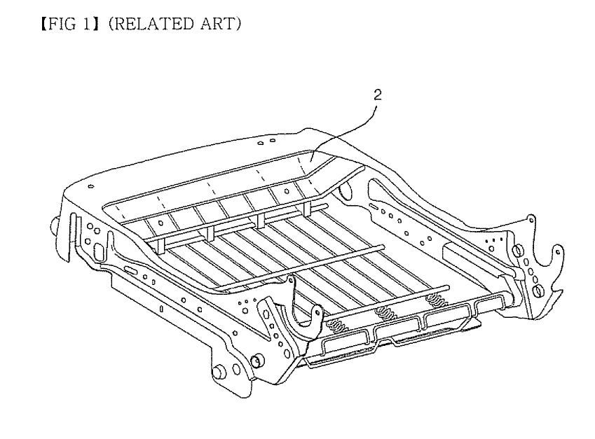

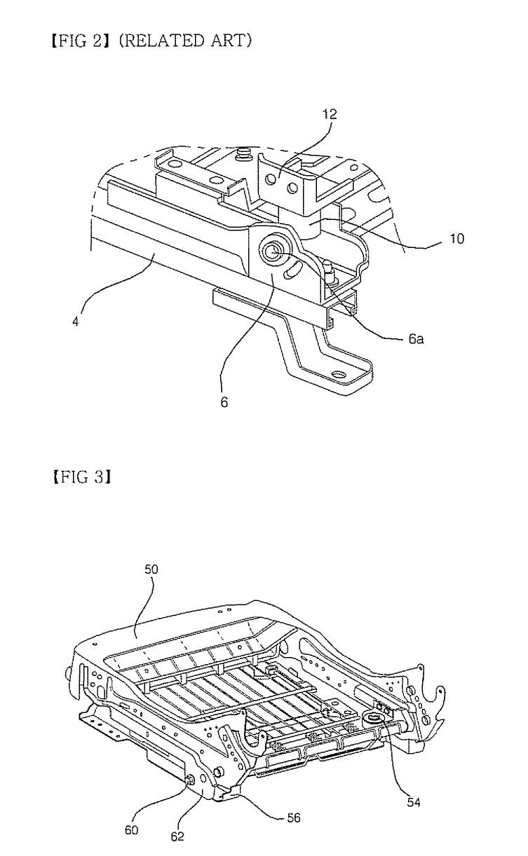

### DETAILED DESCRIPTION OF THE PREFERRED EMBODIMENT

Embodiments of the present invention will now be described with reference to the accompanying drawings.

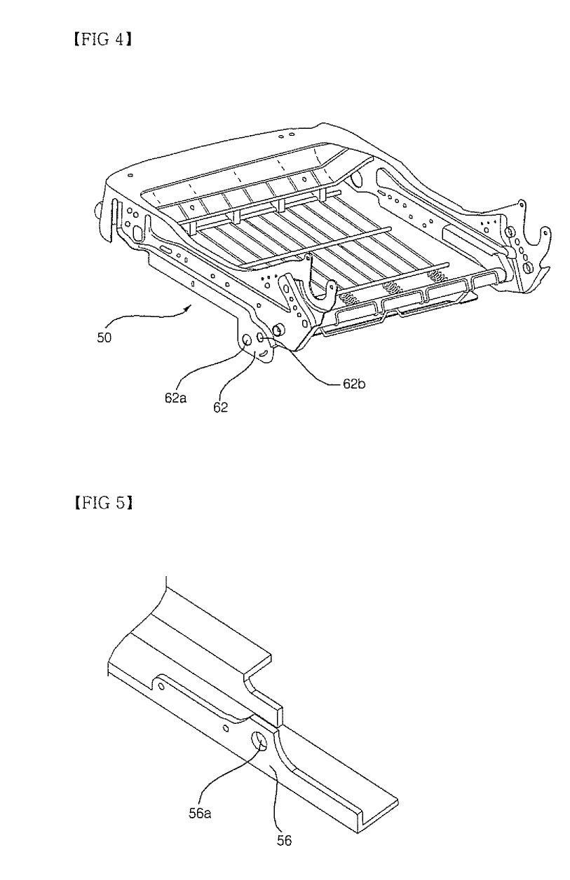

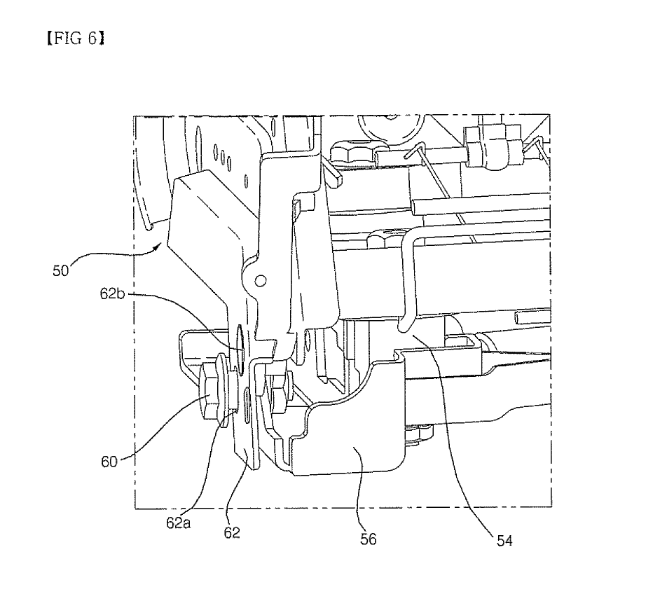

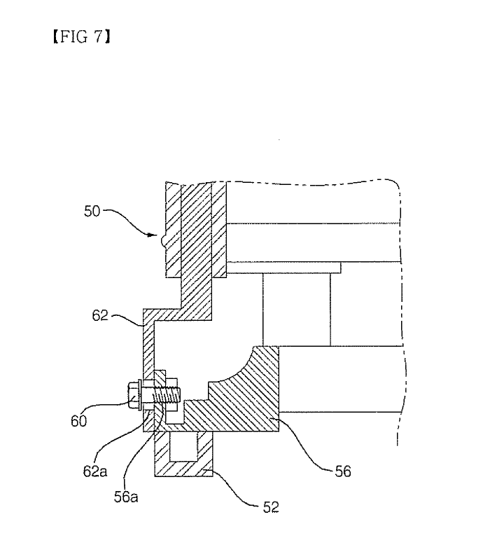

FIG. 3 is a perspective view showing a seat assembly for automobile in accordance with the present invention, FIG. 4 is a perspective view showing a seat cushion frame in accordance with the present invention, FIG. 5 is a perspective view showing a set bracket in accordance with the present invention, FIG. 6 is a perspective view showing a coupled state of a stopper in accordance with the present invention, and FIG. 7 is a side view showing the coupled state of the stopper in accordance with the present invention.

As shown in FIGS. 3 to 7, the seat assembly for an automobile in accordance with the present invention includes a seat cushion frame 50 forming a portion on which a passenger is to be seated, a rail 62 for slidably guiding the seat cushion frame 50 in a forward or backward direction, a passenger sensor 54 provided at a lower side of the seat cushion frame 50 and sensing a load of the passenger, and a support unit provided between the seat cushion frame 50 and the rail 52 and supporting an overload of the seat cushion frame 50 when the seat cushion frame 50 is overloaded.

The seat cushion frame 50 is covered by a seat cushion (not shown) made of a foam or fabric material.

The support unit includes a stopper 60 which is mounted at the side of the rail 52 and limits a downward movement of the seat cushion frame 50 when the seat cushion frame 50 is downwardly moved by longer than a certain distance, and a stopper hooking part 62 protruded from the side of the seat cushion frame 50 so that when the seat cushion frame 50 is downwardly moved by longer than the certain distance, it can be caught by the stopper 60.

The rail 52 is mounted on a floor panel (not shown) of the automobile, and a set bracket 56 is mounted at an upper side of the rail 52.

The stopper 60 is fixedly mounted at the set bracket 56, and a stopper mounting hole 56a for fixedly mounting the stopper 60 therein is formed at the set bracket 56.

As the stopper 60, a pin which is fixedly press-fit at the set bracket 56 can be used, and in the present invention, the stopper 60 is a bolt fixedly engaged in the stopper mounting hole 56a.

With reference to FIG. 4, the stopper hooking part 62 is protruded from the side of the seat cushion frame 50 and downwardly bent to face the side of the set bracket 56.

A stopper through hole 62a through which the stopper 60 penetrates is formed at a position of the stopper hooking part 62 corresponding to the stopper mounting hole 56a.

Herein, an inner circumferential surface of the stopper through hole 62a is separated from an outer circumferential surface of the stopper 60.

That is, in order for the stopper 60 to be caught by the stopper hooking part 62 only when the seat cushion frame 50 is overloaded, preferably, the radius of the stopper through hole 62a is greater than that of the stopper 60.

The space between the stopper through hole 62a and the stopper 60 is determined depending on the distance that the seat cushion frame 50 is downwardly moved when the seat cushion frame 50 is overloaded.

A buckle mounting hole 62b is formed at the stopper hooking part 62, in which a buckle of a seat belt for protecting the passenger is mounted.

The passenger sensor 54 is a pressure sensor for sensing the load of the passenger and is electrically connected with an airbag control unit (not shown) of an airbag system for protecting the passenger when a vehicle crash occurs.

The passenger sensor 54 is installed between the set bracket 56 and the seat cushion frame 50. A lower portion of the passenger sensor 54 is fixedly mounted on an upper surface of the set bracket 56 and an upper portion thereof is coupled with the seat cushion frame 50 by means of a coupling bracket.

The operation of the seat assembly for an automobile constructed as described above will be explained as follows.

When the passenger is seated on the vehicle seat, a corresponding load is applied to the seat cushion frame 50, making the seat cushion frame 50 move downwardly.

Herein, since there is a sufficient space between the stopper through hole 62a and the stopper 60, when the seat cushion frame 50 is downwardly moved by a certain distance, the stopper hooking part 62 is not caught by the stopper 60.

Accordingly, the seat cushion frame 50 is not limited in its downward movement for as long as the certain distance, and the seat cushion frame 50 presses the passenger sensor 54. Then, the passenger sensor 54 senses the pressure applied by the seat cushion frame 50 and transmits a corresponding signal to the airbag control unit (not shown).

Upon receiving the signal, the airbag control unit (not shown) determines a physical figure, the load, a position of the passenger according lo the signal from the passenger sensor 54, and controls deployment of an airbag (not shown).

Meanwhile, if the seat cushion frame 50 is overloaded and thus downwardly moved by longer than the certain distance, the inner circumferential surface of the stopper through hole 62a is caught by the stopper 60.

In other words, the stopper hooking part 62 is caught by the stopper 60 and at this time, the stopper 60 supports the load of the seat cushion frame 50 while limiting the downward movement of the seat cushion frame 50.

Accordingly, since the overload applied to the seat cushion frame 50 can be distributed to the passenger sensor 54 and the stopper 60, the excessive pressure is not wholly applied to the passenger sensor 54, and thus, the passenger sensor can be prevented from being damaged or deformed.

As described above, the seat assembly for an automobile in accordance with the present invention has the following effects.

First, since the overload applied to the seat cushion frame cannot be entirely applied to the passenger sensor, the passenger sensor can be prevented from being damaged or deformed.

Second, since the support unit is formed as the stopper for limiting the downward movement of the seat cushion frame by longer than the certain distance, its structure is simple and its assembling is easy.

Third, since the stopper hooking part is integrally formed at the seat cushion frame such that it can be caught by the stopper when the seat cushion frame is downwardly moved by longer than the certain distance, the structure is simple and the cost can be reduced.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention It is intended that the scope of the invention be defined by the claims appended hereto and their equivalents.

1. A seat assembly for an automobile comprising:
a seat cushion frame that forms a seating portion on which a passenger is to be seated;
a rail that slidably guides the seat cushion frame in forward and rearward directions;
a passenger sensor provided at a lower side of the seat cushion frame that senses a load of the passenger; and
a support unit provided between the seat cushion frame and the rail that supports an overload of the seat cushion frame when the seat cushion frame is overloaded.

2. The seat assembly of claim 1, wherein the support unit is a stopper mounted at the side of the rail that limits downward movement of the seat cushion frame when the seat cushion frame is downwardly moved by a distance greater than a predetermined distance.

3. The seat assembly of claim 2, wherein the support unit comprises a stopper hook extending from the side of the seat cushion frame to allow the seat cushion frame to be caught by the stopper when the seat cushion frame is downwardly moved by a distance longer than the predetermined distance.

4. The seat assembly of claim 2, wherein the stopper is mounted at a seat bracket provided at an upper side of the rail.

5. The seat assembly of claim 4, wherein a stopper mounting hole that receives the stopper therein is formed at the seat bracket.

6. The set assembly of claim 5r wherein the stopper is bolt engaged in the stopper mounting hole.

7. The seat assembly of claim 31 wherein a stopper through hole that allows the stopper to penetrate therethrough is provided at the stopper hook.

8. The seat assembly of claim 7, wherein an inner circumferential surface of the stopper through hole is separated by a certain interval from an outer circumferential surface of the stopper.

9. The seat assembly of claim 31 wherein a buckle mounting hole to allow a buckle of a seat belt to protect the passenger to be mounted therein is provided at the stopper hook.
